(19) United States
(12) Patent Application Publication
(10) Pub. No.: US 2016/0257238 A1
(43) Pub. Date: Sep. 8, 2016

(54) TRUCK TAIL DOOR ASSEMBLY

(71) Applicant: WONG FONG ENGINEERING WORKS (1988) PTE LTD, Singapore (SG)

(72) Inventor: Yin Jheow Ban, Singapore (SG)

(21) Appl. No.: 15/032,035

(22) PCT Filed: Oct. 24, 2014
(86) PCT No.: PCT/SG2014/000499

§ 371 Date: Apr. 25, 2016

(30) Foreign Application Priority Data
Oct. 25, 2013 (SG) 2013079827

(51) Int. Cl. B60P 1/44; B65G 67/02; B65G 69/24; B60J 5/10

(52) U.S. Cl. CPC B60P 1/4414; B60J 5/108; B65G 67/02; B65G 69/24; B65G 2814/03

(57) ABSTRACT

The present invention relates to a tail door assembly, such as for a cargo container or a truck. The tail door assembly includes a left door rotatable about a left vertical axis, and a right door rotatable about a right vertical axis. Further, there is a first set of actuators, wherein a left actuator is coupled to the left door and a right actuator is coupled to the right door. The first set of actuators is operable for actuating the left and right doors synchronously or simultaneously about a horizontal axis between a vertical position and a horizontal position. The tail door assembly can be selectively operated or used like a usual pair of out-swinging doors, and also like a single tail gate which can be lowered from a vertical closed position to a horizontal open position.

### TECHNICAL FIELD

The present disclosure relates to a tail door assembly for a cargo carrying structure, machine, or vehicle, such as a truck.

### BACKGROUND

Vehicles such as trucks often have a tail door attached to the rear of the truck to allow access to a cargo compartment. The truck can be a flatbed truck whereon a container may be mounted. The container can be a freight container conforming to ISO standards, and comprises a rear entry door. Thus, a tail door is used to access the rear entry door of the container on the truck. In another example, the container can be directly mounted on the chassis of the truck.

When the tail door is in the closed position, i.e., a vertical position, the platform of the tail door covers the doors of the container, thus preventing the container doors from swinging outwards. In order to access the inside of the container, the tail door needs to be rotated outwards or downwards to an open position, i.e., a horizontal position. This removes the blockage of the container doors, allowing the container doors to be opened. A problem associated with this configuration is that it is time consuming to wait for the tail door to be lowered down before gaining access into the container.

In some situations, cargo needs to be loaded into the container from a loading/unloading bay, and/or unloaded from the container to the bay. The loading/unloading bay is typically a raised platform, such that the platform of the bay is flush with the floor of the container or with the flatbed of the truck. To accomplish this loading and/or unloading, the truck needs to be reversed towards the bay area. If the truck does not have a tail door, the truck can be reversed until the container doors are proximate to the bay area, such that personnel can step across from the platform bay to the container floor. If the truck does have a tail door, the bay area will hinder the opening of the tail door and prevent access into the container. In this situation, the truck needs to be reversed until it is positioned a given distance away from the bay area to allow the tail door to open. This requires an unnecessary amount of time and a certain level of trial and error for adjustment of the position of the truck with respect to the bay area.

Safety may also be compromised when personnel are loading goods onto the platform of the tail door when it is open, because the doors of the container could also be open at the same time. The personnel may thus be prone to injuries caused by the container doors while they are on the tail door platform. In some countries, modifying the truck to include a tail door feature in addition to the doors of the container may be considered as an illegal modification.

The addition of the tail door to be used in conjunction with the doors of the container also adds unnecessary extra load to the truck. Disadvantageously, this increases the loads on the axles of the truck and leads to higher fuel consumption.

Therefore, there is an apparent need for an improved tail door for a truck in order to address at least one of the foregoing problems.

### DISCLOSURE

Embodiments in accordance with the present invention provide a tail door assembly for a cargo carrying structure, machine, or vehicle such as a truck. The tail door assembly comprises a left door pivotable or rotatable about a left vertical axis, and a right door pivotable or rotatable about a right vertical axis. Further, the tail door assembly includes a first set of actuators, wherein a left actuator is coupled to the left door and a right actuator is coupled to the right door. The first set of actuators is operable for actuating the left and right doors synchronously relative to or about a horizontal axis between a vertical position or orientation and a horizontal position or orientation relative to the ground or another surface (e.g., a floor).

An advantage provided by the present invention is that the out-swinging of the doors of the container, and the rotating of a tail door between a vertical position and a horizontal position, as described in the background art, are now performable by a single assembly in which both of such functions are integrated. A user thus has a choice to use the out-swinging doors, such as when loading cargo from a raised platform bay, or to open both the left and right doors simultaneously outwards (between vertical and horizontal positions), such as when loading cargo from the ground or another surface. Thus, a single tail door assembly in accordance with an embodiment of the present invention can selectively or selectably provide (a) a pair of out-swinging doors (e.g., left and right side out-swinging doors), wherein each out-swinging door can pivot, rotate, or swing outward when opening (and correspondingly, swing inward when closing) relative to a set of vertical axes (e.g., left and right vertical axes), as well as (b) a tail door that can be lowered when opening from a vertical or closed position to a horizontal or open position (and correspondingly, raised when closing from the horizontal or open position to the vertical or closed position). Such selective operation of the tail door assembly can occur in response to a user generated signal (e.g., an electronic, electromechanical, and/or hydraulic signal generated by way of user interaction with a user interface, for instance, by way of pushing a button or changing the state of a switch). Thus, embodiments of the the tail door assembly in accordance with the present invention can thus be used in a manner identical, essentially identical, or analogous to (a) a conventional pair of out-swinging doors, as well as (b) a conventional tail door, wherein the tail door can be lowered from a vertical position, i.e. closed position, to a horizontal position, i.e., an open position. The left and right doors can be rotated from the vertical position to the horizontal position, and vice versa, as a single platform piece. Such synchronous rotation of the doors does not allow one of the left and right doors to open while the other remains closed.

Preferably, the first set of actuators is further operable for adjusting a height of the left and right doors in the horizontal position. In addition to rotating the tail door assembly outwards, the first set of actuators can also be used to raise or lower the tail door assembly, while maintaining the tail door assembly in its horizontal position or orientation. Alternatively or additionally, there is a second set of actuators operable for adjusting the height of the left and right doors. Advantageously, a user can place cargo from the ground to the tail door platform which has been lowered to the ground, and then operate the first set of actuators and/or the second set of actuators to raise the tail door platform.

Preferably, each of the rotation of the left door about the left vertical axis and the rotation of the right door about the right vertical axis can occur across a wide angular range, for instance, between 0 and 270 degrees. When used with a container, the rotation of the doors at 270 degrees allows the doors to be opened until they are parallel or substantially parallel to the sides of the container. This allows the driver of the truck to clearly see the rear of the truck with their side-view mirrors. Moreover, this is important because of safety issues when the truck is being reversed towards a raised bay area while the doors are opened. It allows the driver to monitor any signs of danger and/or risk of collision with the bay area when reversing the truck.

The left and right doors are preferably lockable to prevent unwanted rotation about the horizontal axis. Additionally, the left door is preferably lockable to prevent unwanted rotation about the left vertical axis, and the right door is also preferably lockable to prevent unwanted rotation about the right vertical axis. These features advantageously lock the various components of the tail door securely, and prevents them from accidentally opening, especially when the truck is in motion.

The tail door assembly can be configured for use with a container structure. The container structure can be a freight container, for instance, a freight container conforming to ISO standards. A weather seal can be formable between the tail door assembly and the container structure. This advantageously allows a user to modify the existing doors of the container with an embodiment of the tail door in accordance with the present invention. In addition, the weather seal between the tail door assembly and the container when the doors are in the closed position prevents, for example, rain from entering into the container and potentially damaging any goods stored therein.

Alternatively or additionally, the tail door assembly can comprise a frame structure around the left and right doors. The frame structure includes a left hinge or hinge structure corresponding to or forming at least portions of the left vertical axis and a right hinge or hinge structure corresponding to or forming at least portions of the right vertical axis. The frame structure provides a supporting structure to which the left and right doors can be hinged or pivotally supported. Further, when the left and right doors are rotated about the horizontal axis downwards from a vertical closed position to a horizontal open position, the frame structure can rotate synchronously with the left and right doors.

The tail door assembly can be coupled to the chassis of a cargo carrying vehicle such as a truck. This chassis is the most structurally stable part of the vehicle, and keeps the tail door assembly securely mounted as a component of the vehicle.

A tail door assembly according to the present invention is thus disclosed hereinabove. Various features, aspects, and advantages of the present invention will become more apparent from the following detailed description of the embodiments of the present invention, by way of non-limiting examples only, along with the accompanying drawings in which like numerals represent like components.

### BRIEF DESCRIPTION OF THE DRAWINGS

FIG. 1 shows an isometric view of an embodiment of a container truck with the tail door assembly according to the present invention, wherein the tail door assembly is in the vertical closed position.

FIG. 2 shows a side view of the embodiment of FIG. 1.

FIG. 3 shows a rear view of the embodiment of FIG. 1.

FIG. 4 shows a top view of the embodiment of FIG. 1.

FIG. 5 shows an isometric view of an embodiment of a container truck with the tail door assembly according to the present invention, wherein the tail door assembly is in the horizontal open position.

FIG. 6 shows a side view of the embodiment of FIG. 5.

FIG. 7 shows a rear view of the embodiment of FIG. 5.

FIG. 8 shows a top view of the embodiment of FIG. 5.

FIG. 9 shows an isometric view of an embodiment of a container truck with the tail door assembly according to the present invention, wherein the left and right doors of the tail door assembly are rotated about the respective vertical axes to an open position.

FIG. 10 shows a side view of the embodiment of FIG. 9.

FIG. 11 shows a rear view of the embodiment of FIG. 9.

FIG. 12 shows a top view of the embodiment of FIG. 9.

FIG. 13 shows a side view of an embodiment of a flatbed truck with the tail door assembly according to the present invention, wherein the tail door assembly is in the horizontal open position.

FIG. 14 shows a side view of an embodiment of a flatbed truck with the tail door assembly according to the present invention, wherein the tail door assembly is in the vertical closed position.

FIG. 15 shows an enlarged side view of the tail door assembly according to the present invention, wherein the tail door assembly is in the vertical closed position.

### DETAILED DESCRIPTION OF PARTICULAR EMBODIMENTS

Unless explicitly stated otherwise, in the description herein the recitation of particular numerical values or value ranges is taken to be a recitation of particular approximate numerical values or approximate value ranges. For instance, a given numerical value or value range recited below should be interpreted or defined as an approximate numerical value or value range within +/−20%, +/−15%, +/−10%, or +/−5% of the value or value range recited. The use of “/” herein is understood to mean “and/or” unless otherwise indicated.

Reference is now made in detail to different representative embodiments in accordance with the present invention. While aspects of the invention will be described in conjunction with the embodiments provided herein, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description, numerous specific details are set forth in order to provide a thorough understanding of the present invention. However, it will be recognized by one of ordinary skill in the art that the present invention may be practiced without these specific details. In other instances, well-known methods, procedures, components, and circuits have not been described in detail as not to unnecessarily obscure aspects of the embodiments of the present invention.

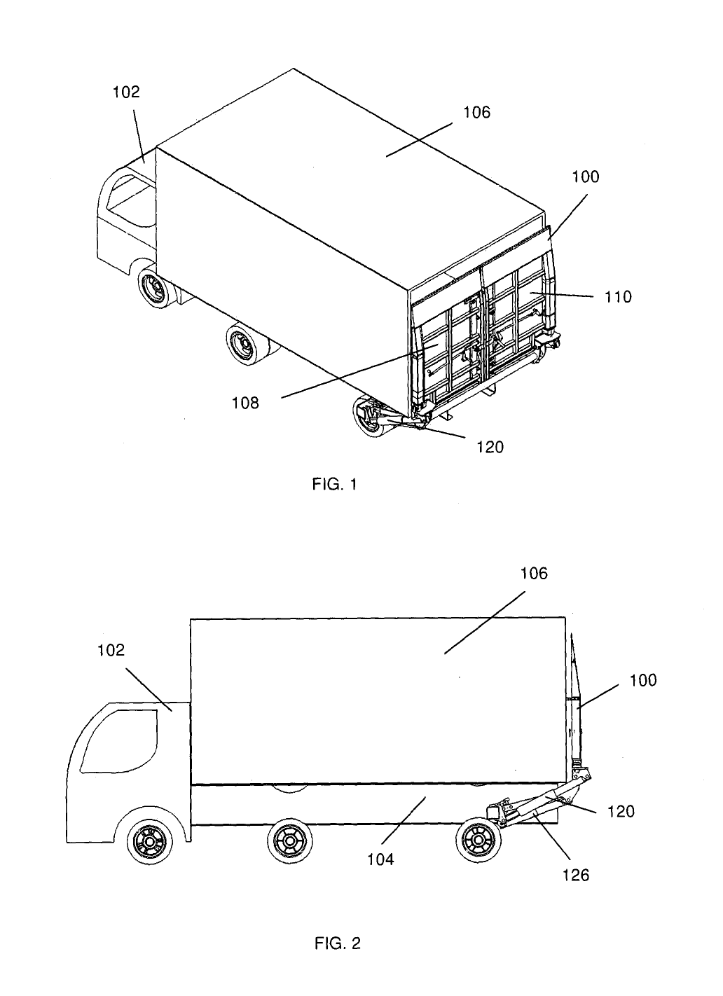

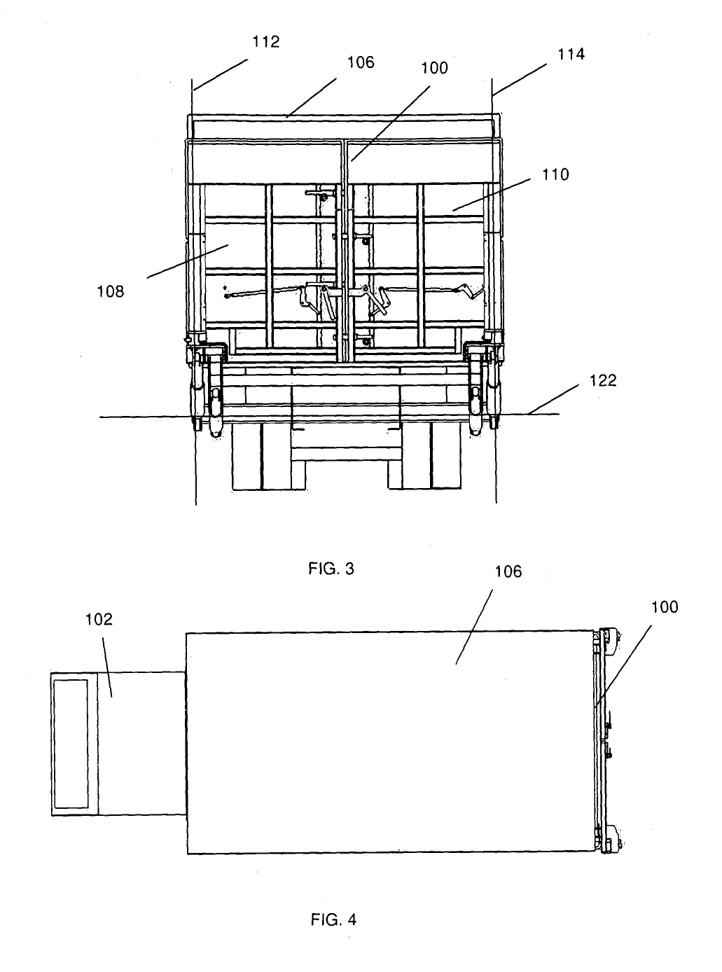

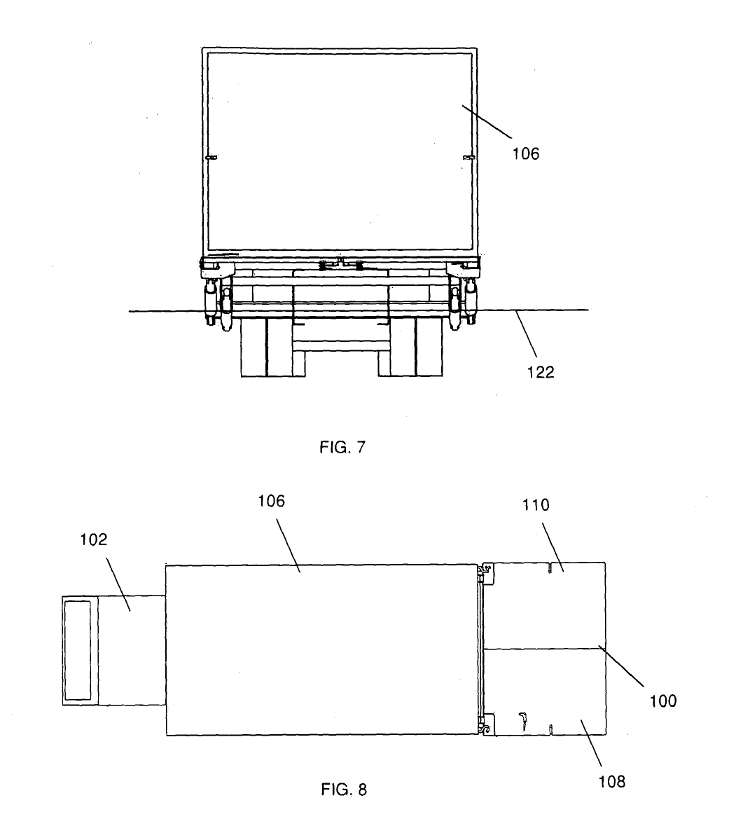

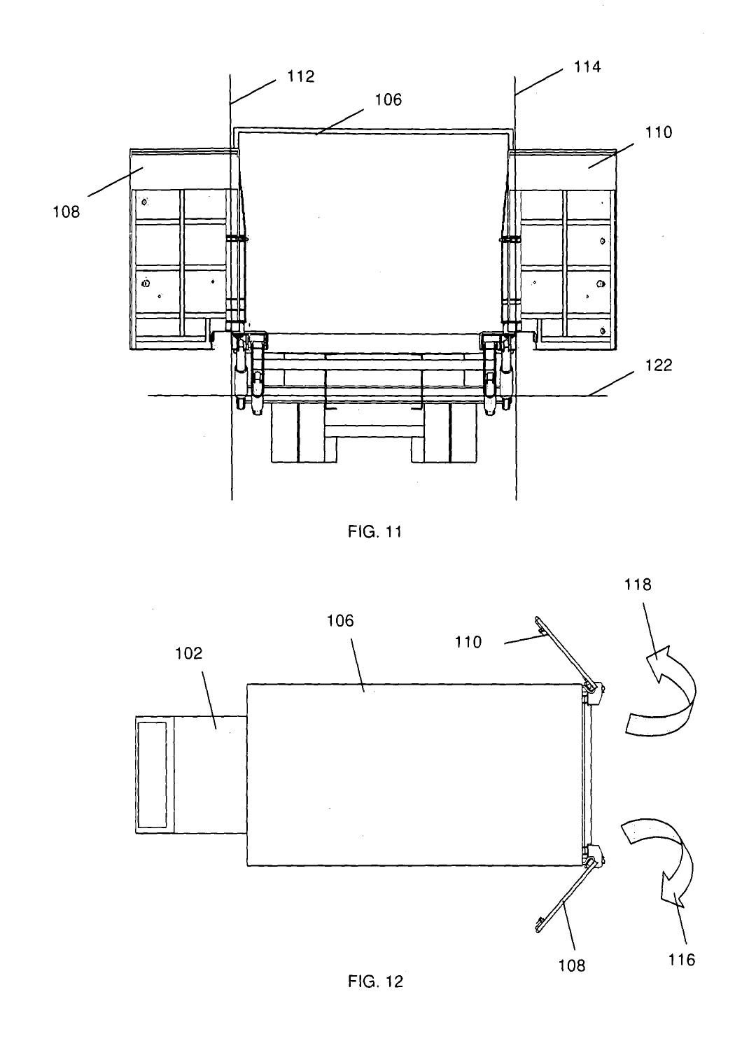

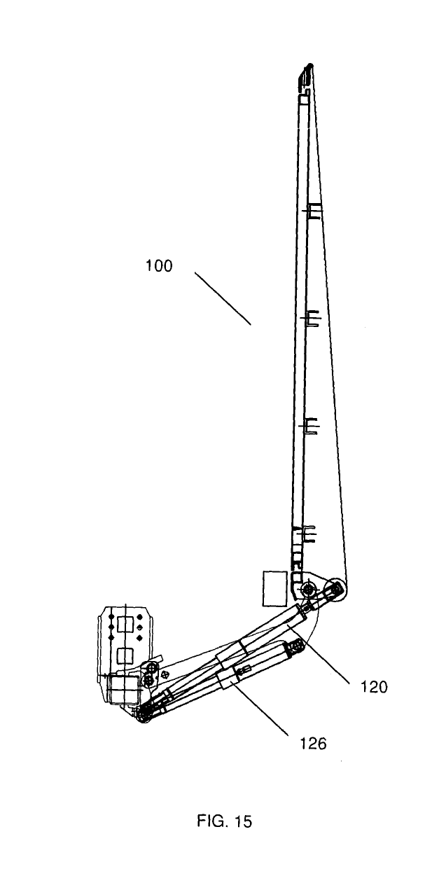

For purposes of brevity and clarity, descriptions of embodiments of the present invention are limited hereinafter to a tail door assembly for a truck, in accordance with the drawings in FIG. 1 to FIG. 15. This however does not preclude embodiments of the invention where fundamental principles prevalent among the various embodiments of the invention such as operational, functional or performance characteristics are required.

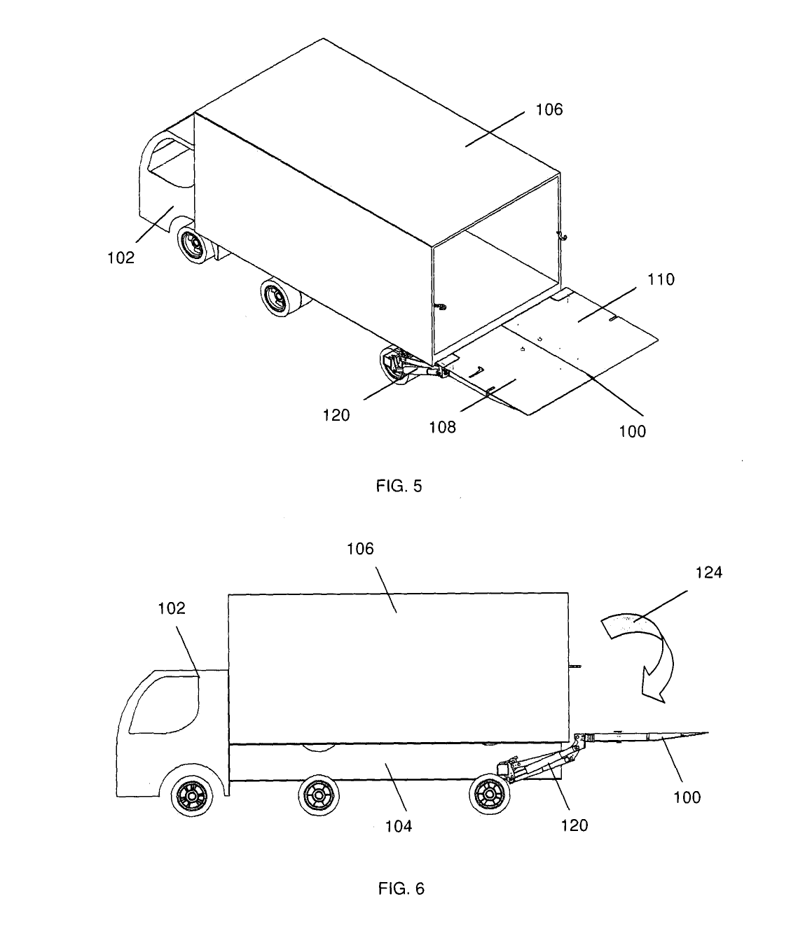

In a first embodiment of the present invention, a tail door assembly 100 for a cargo carrying machine or vehicle such as a truck 102 is described hereinafter. The tail door assembly 100 can be coupled to the chassis 104 of the truck 102, wherein the tail door assembly 100 is used to gain access into a container structure 106 mounted on the truck 102. The container structure 106 can be a freight container conforming to ISO standards in terms of dimensions. It can also be essentially any other type of container of other design. In this embodiment, there are no rear doors in the freight container 106; only the tail door assembly 100 can be used to gain access into the container 106. FIG. 1 to FIG. 4 show the truck 102 with the container 106 mounted thereon, and shows the tail door assembly 100 in a closed or vertical position. FIG. 5 to FIG. 8 show the same embodiment, except that the tail door assembly 100 is now in an open or horizontal position.

The tail door assembly 100 comprises a left door or door panel 108 which is rotatable about a left vertical axis 112. The tail door assembly 100 also comprises a right door or door panel 110 which is rotatable about a right vertical axis 114. There is a first set of actuators 120, which includes a left actuator coupled to the left door 108 and a right actuator coupled to the right door 110. The actuators 120 can include or be hydraulic cylinders powered a separate hydraulic pump, and/or mechanical actuators powered by an electrical power generator. One end of the actuators 120 is secured directly onto the chassis 104 of the truck 102, while the other end is coupled to the left and right doors 108 and 110. The first set of actuators 120 is operable for actuating the left door 108 and the right door 110 synchronously about a horizontal axis 122 between or from a vertical position to a horizontal position, along a lowering/raising direction 124 indicated by the arrow. The coupling positions of the actuators 120 on the tail door assembly 100 can be calculated by the skilled person based on the force exerted or applied by and/or upon the actuators 120, the dimensions and masses of the left and right doors 108 and 110, and the position of the horizontal axis 122.

In various embodiments, extension and retraction of the actuators 120 causes the left door 108 and the right door 110 to rotate synchronously/simultaneously about the horizontal axis 122 along the direction 124. With respect to multiple embodiments, synchronously/simultaneously is intended to mean that the left door 108 and the right door 110 move together as a single unit or platform when rotated about the horizontal axis 122. Moreover, rotation as a single platform prevents one of the left door 108 and right door 110 from opening while the other door remains closed. The rotation of the doors 108 and 110 as a single platform about the horizontal axis 122 allows the tail door assembly 100 to move between a closed vertical position and an open horizontal position, or any other position in between, in a controlled or controllable manner. In some embodiments, the tail door assembly 100 can also be configured to open beyond the horizontal position, such as until the tail door assembly 100 contacts the ground or another surface.

The first set of actuators 120 is also operable for adjusting the height of the doors 108 and 110 as a single platform when the platform has been opened into the horizontal position. Thus, in addition to rotating the left and right doors 108 and 110 outwards, the first set of actuators 120 can also be used to raise or lower the doors 108 and 110, while maintaining the two doors 108 and 110 as a single platform in their horizontal position or orientation. In one example, a user can firstly open the doors 108 and 110 by operating the actuators 120 to rotate the two doors 108 and 110 as a single platform about the horizontal axis 122. Once the platform, formed by the left door 108 and the right door 110, is in the horizontal position after opening, the platform is typically substantially flush with or parallel to the inside floor of the container 106. The horizontal platform can be further lowered towards the ground or another surface by operating the actuators 120. In some embodiments, a separate second set of actuators 126 can be used in place of, or to assist, the first set of actuators 120 for the lowering and rising of the single platform relative to the ground while maintaining the platform in its horizontal position or orientation with respect to the ground or other surface. After the platform has been lowered to the ground or other surface, the user can then transport cargo or goods from the ground or other surface onto the platform. Thereafter, the cargo or goods can be raised upwards by operating the first and/or second actuators 120 and 126, possibly together with the user on the platform, before continuing to move the cargo or goods into the container 106. The single platform can be raised such that the left and right doors 108 and 110 are disposed in their closed position, covering the container 106, in a manner analogous and opposite to that described above with respect to their lowering as a single platform, in a manner understood by one having ordinary skill in the relevant art.

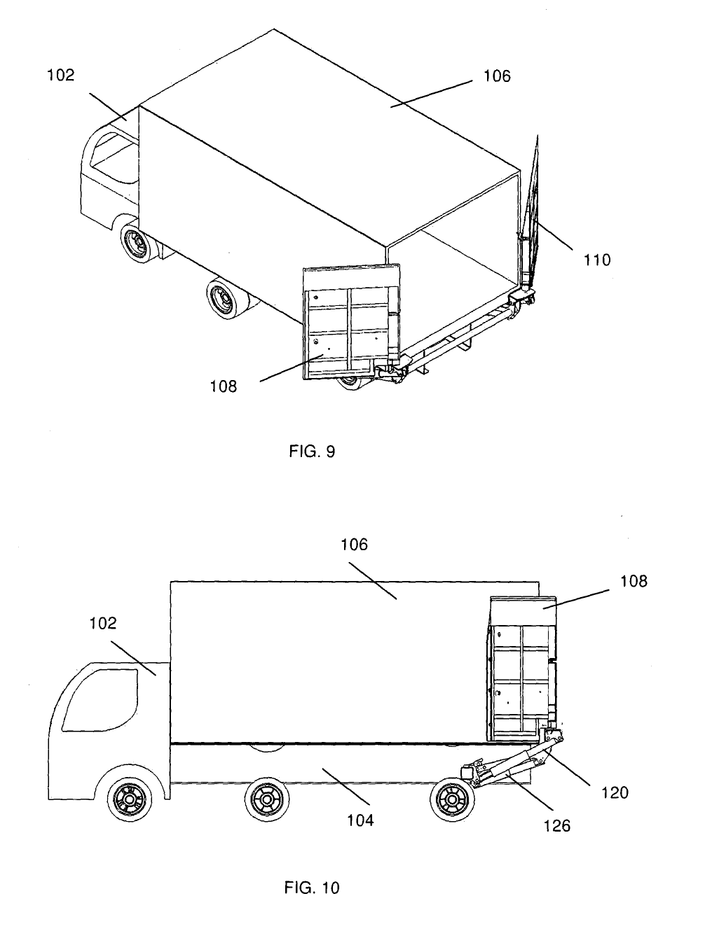

In addition to being able to rotate about the horizontal axis 122, the left door 108 is selectively or selectably rotatable (openable/closeable) about the left vertical axis 112 along the direction indicated by the arrow 116, and the right door 110 is selectively or selectably rotatable (openable/closeable) about the right vertical axis 114 along the direction indicated by the arrow 118. FIG. 9 to FIG. 12 shows the truck with the tail door assembly having the left and right doors swung open along directions 116 and 118, respectively. The rotation of the doors 108 and 110 about the vertical axes 112 and 114 can occur manually, and/or can by actuated with any form of actuation, mechanical, and/or hydraulic means known to the skilled person. In various embodiments, the angle of rotation for the doors 108 and 110 about the vertical axes 116 and 118 is between 0 and at least 90-180 degrees, and in multiple embodiments this angle of rotation is 0 to 270 degrees. When the tail door assembly 100 is used with the container 106 in this outward rotation configuration relative to the left and right vertical axes 112 and 114, the rotation of the doors 108 and 110 at up to 270 degrees allows the doors 108 and 110 to be opened until they are parallel to the sides of the container 106. This allows the driver of the truck 102 to clearly see the rear of the truck 102 with the side-view mirrors. Moreover, this is important because of safety issues when the truck 102 is being reversed towards a raised bay area while the doors 108 and 110 are opened. It allows the driver to monitor any signs of danger and/or risk of collision with the bay area when reversing the truck 102. In some prior art trucks, the tail doors cannot be opened fully with respect to such vertical axes, thus blocking the view of the driver when reversing.

An advantage provided by the tail door assembly 100 in accordance with the first embodiment described above is that there is a single assembly 100 that allows the left and right doors 108 and 110 to swing outwards about the vertical axes 112 and 114 along the directions 116 and 118, and also allows the doors 108 and 110 to rotate downwards as a single platform about the horizontal axis 122 along the direction 124. There is thus a choice with respect to how the user can operate the tail door assembly 100. For example, the user can use the out-swinging left and right doors 108 and 110 by rotating them about the left and right vertical axes 112 and 114, respectively. This is usually used when loading cargo from a loading/unloading bay with a raised platform. The truck 102 will be reversed until the tail door assembly 100 is proximate to the bay area, such that personnel can step across from the raised platform to the container 106 floor after opening the doors 108 and 110. The user can also choose to rotate the doors 108 and 110 as a single platform about the horizontal axis 122 from the vertical closed position to the horizontal open position. This is usually used when loading cargo directly from the ground as described above.

Thus, a single tail door assembly 100 in accordance with the present invention can be used as the usual pair of out-swinging doors; and this single tail door assembly 100 can also be used in a manner identical, essentially identical, or analogous to a conventional tail door described in the background, wherein the tail door can be lowered from a vertical position, i.e. closed position, to a horizontal position, i.e. open position. By integrating these functions together in a single assembly 100, users can quickly open up the tail door assembly 100 when loading cargo from a raised platform bay, and also used the same tail door assembly 100 as a lift to raise cargo from the ground or other surface to the container floor level. There is a significant time reduction in that there is no need to firstly open up doors along the direction 124 and then open out-swinging doors along the directions 116 and 118, as in existing prior art.

The left and right doors 108 and 110, which function as a single platform when rotated about the horizontal axis 122, are lockable to prevent unwanted or unintended rotation about the horizontal axis 122. The left door 108 is also lockable to prevent unwanted or unintended rotation about the left vertical axis 112, and the right door 110 is also lockable to prevent unwanted or unintended rotation about the right vertical axis -114. The locking of the doors 108 and 110 can be by way locking mechanisms such as hooks or latches, or the locking mechanisms can also be long latch locks that are normally used with ISO freight containers. Any other (e.g., similar) manual or automated locking mechanism or means known to the skilled person can also be used in addition or in place of the aforementioned locking mechanisms. These locking mechanisms secure the various components of the tail door assembly 100, and prevent them from accidentally opening, particularly when the truck is in motion.

In the first embodiment, the tail door assembly 100 is configured for use with a container 106. When the tail door assembly 100 is in the closed position, i.e. when the left and right doors 108 and 110 are in the vertical position, the tail door assembly 100 can form a weather seal with the container 106. Such a weather seal can be a rubberized seal between the edges of the tail door assembly 100 and the container 106, or any other similar means known to the skilled person. The weather seal protects the container 106 from the external weather elements, especially when the container 106 is used for transporting fragile cargo or goods. If rain were to enter into the container 106 possibly due to a leakage of the weather seal, there could be potential damage to the cargo or goods stored inside the container 106.

In various embodiments, the tail door assembly 100 is coupled to the chassis 104 of the vehicle/truck 102. The chassis 104 is the most structurally stable part of the truck 102 and keeps the tail door assembly 100 securely mounted as a component of the truck 102. The tail door assembly 100 can be mounted by means of a steel plate and non-permanent fasteners such as nuts and bolts into the chassis 104. The first and second sets of actuators 120 and 126 are positioned between this part of the chassis 104 and the tail door assembly 100. The coupling connections between the actuators 120 and 126 and the chassis 104 and the tail door assembly 100 are also through means of non-permanent fasteners described above. However, permanent means such as welding may also be used. Alternative to the chassis, the tail door assembly 100 can be coupled directly to the container 106. The container 106 can then be mounted onto the chassis 104.

Some embodiments can also include a sensing system in the tail door assembly 100 for preventing unwanted or undesirable simultaneous rotations of the doors 108 and 110. Specifically, the sensing system can only allow the actuators 120 to rotate the doors 108 and 110 about the horizontal axis 122 along the direction 124 only when the doors 108 and 110 are fully closed with respect to the vertical axes 112 and 114 (along the directions 116 and 118). There can be sensors and electrical circuitry installed on and/or around the doors 108 and 110 to detect the full closure thereof. Electrical circuitry connecting the actuators 120 and the doors 108 and 110, and programming devices, can also be included for implementation of this feature. It will be apparent to the skilled person that variations and modifications for this feature are possible.

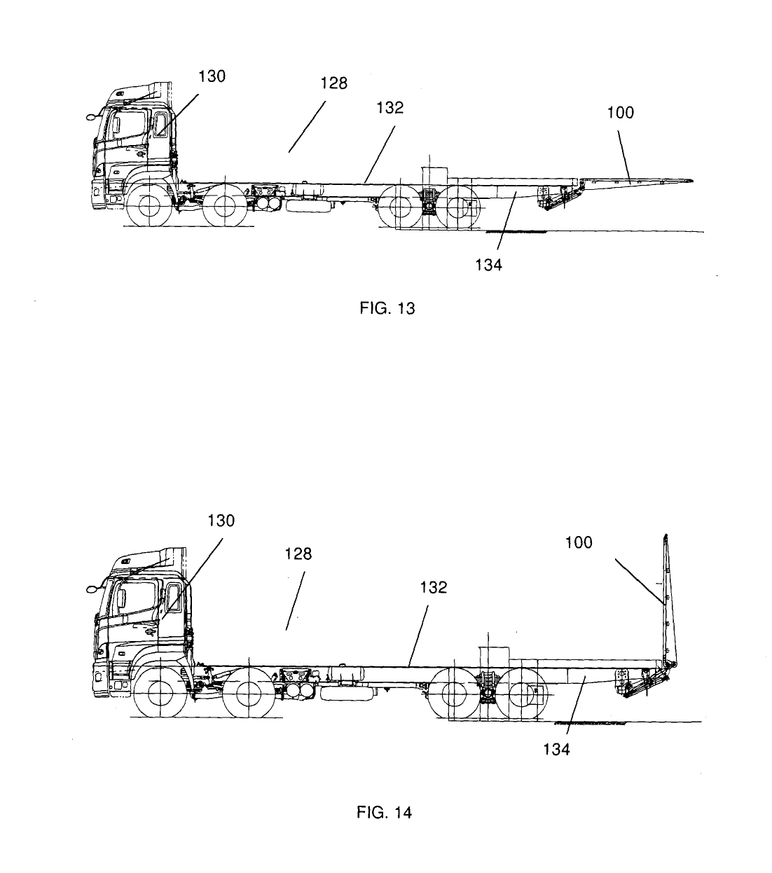

In another or second embodiment of the present invention, as shown in FIG. 13 and FIG. 14, the tail door assembly 100 is attachable or attached to a flatbed truck 128. There is no container structure mounted between the tail door assembly 100 and the truck cab 130. The tail door assembly 100 thus serves as a means to access the flatbed cargo area 132 of the flatbed truck 128. Without the presence of a container, the tail door assembly 100 is mounted directly on the chassis 134 of the flatbed truck 128. This embodiment can be used for large cargo which may not be able to fit into a container. The cargo can be strapped down securely onto the flatbed cargo area 132.

In both embodiments, there may be a need to structurally strengthen the tail door assembly 100, for instance, at or along the edges thereof. Thus, the tail door assembly 100 can be modified to include a frame structure (e.g., a fixed frame structure) around the doors 108 and 110. Such a frame structure comprises a left hinge or hinge structure corresponding to or forming at least portions of the left vertical axis 112 and a right hinge or hinge structure corresponding to or forming at least portions of the right vertical axis 114. The frame structure provides a supporting structure to which the left and right doors 108 and 110 can be hinged or pivotally supported. Further, when the doors 108 and 110 are rotated about the horizontal axis 122 downwards from the vertical closed position to the horizontal open position (along the direction 124), the frame structure can rotate synchronously with the left and right doors 108 and 110 along the same direction 124.

For fabrication and manufacturing of the tail door assembly 100, the skilled person can begin from an existing pair of out-swinging doors, and then modify it to include a horizontal axis 122 for rotation in the direction 124. Alternatively, the skilled person can begin from a tail gate which is capable of rotating in the direction 124, and then modify the tail gate into separate or separable doors that are rotatable about the left and right vertical axes 112 and 114 in the directions 116 and 118.

In a foregoing manner, a tail door assembly for a truck is described according to different embodiments of the invention. Although only some embodiments of the present invention are disclosed herein, it will be apparent to one skilled in the art in view of this disclosure that numerous changes and/or modifications can be made to the disclosed embodiments without departing from the scope of the present invention.

1. A tail door assembly for a container or a vehicle, comprising:
a left door rotatable about a left vertical axis;
a right door rotatable about a right vertical axis; and
a first set of actuators having a left actuator coupled to the left door and a right actuator coupled to the right door;
wherein the first set of actuators is operable for rotating the left and right doors synchronously about a horizontal axis between a vertical position and a horizontal position.

2. The tail door assembly according to claim 1, wherein the first set of actuators is further operable for adjusting a height of the left and right doors while the left and right doors are maintained in the horizontal position.

3. The tail door assembly according to claim 1, further comprising a second set of actuators operable for adjusting a height of the left and right doors in the horizontal position.

4. The tail door assembly according to claim 1, wherein each of the rotation of the left door about the left vertical axis and the rotation of the right door about the right vertical axis is between 0 and 270 degrees.

5. The tail door assembly according to claim 1, wherein the left and right doors are lockable for preventing rotation about the horizontal axis.

6. The tail door assembly according to claim 1, wherein the left door is lockable for preventing rotation about the left vertical axis, and the right door is lockable for preventing rotation about the right vertical axis.

7. The tail door assembly according to claim 1, wherein tail door assembly is configured for use with a container structure.

8. The tail door assembly according to claim 7, wherein a weather seal is formable between the tail door assembly and the container structure.

9. The tail door assembly according to claim 1, further comprising a frame structure around the left and right doors.

10. The tail door assembly according to claim 9, wherein the frame structure comprises:
a left hinge corresponding to the left vertical axis; and
a right hinge corresponding to the right vertical axis.

11. The tail door assembly according to claim 9, wherein the frame structure is rotatable with the left and right doors about the horizontal axis between the vertical position and the horizontal position.

12. The tail door assembly according to claim 1, wherein the tail door assembly is coupled to a chassis of the truck.

13. The tail door assembly according to claim 4, wherein the left door is lockable for preventing rotation about the left vertical axis, and the right door is lockable for preventing rotation about the right vertical axis.

14. The tail door assembly according to claim 10, wherein the frame structure is rotatable with the left and right doors about the horizontal axis between the vertical position and the horizontal position.

15. The tail door assembly according to claim 2, wherein the tail door assembly is coupled to a chassis of the truck.

16. The tail door assembly according to claim 3, wherein the tail door assembly is coupled to a chassis of the truck.

17. The tail door assembly according to claim 4, wherein the tail door assembly is coupled to a chassis of the truck.

18. The tail door assembly according to claim 5, wherein the tail door assembly is coupled to a chassis of the truck.

19. The tail door assembly according to claim 6, wherein the tail door assembly is coupled to a chassis of the truck.

20. The tail door assembly according to claim 7, wherein the tail door assembly is coupled to a chassis of the truck.
